(19) United States
(12) Patent Application Publication
(10) Pub. No.: US 2018/0311851 A1
(43) Pub. Date: Nov. 1, 2018

(54) AN ELECTROMECHANICAL DEVICE FOR REMOVING MATERIAL FROM AN ENCLOSED SPACE

(71) Applicant: RELIANCE INDUSTRIES LIMITED, Mumbai, Maharashtra (IN)

(72) Inventors: Raja Janardan CHOUDHARY, Bhagalpur, Bihar (IN); Hemantkumar Kameshwar CHOUDHARY, Karjain, Bazar, Bihar (IN)

(73) Assignee: RELIANCE INDUSTRIES LIMITED, Mumbai, Maharashtra (IN)

(21) Appl. No.: 15/768,391

(22) PCT Filed: Sep. 16, 2016
(86) PCT No.: PCT/IB2016/055525

§ 371 Date: Apr. 13, 2018

(30) Foreign Application Priority Data
Oct. 13, 2015 (IN) 3880/MUM/2015

(51) Int. Cl. B26D 7/18; B26D 5/02; B26D 5/08; C10G 45/02

(52) U.S. Cl. CPC B26D 7/1863; B26D 5/02; C10G 2300/70; C10G 45/02; B26D 5/08

(57) ABSTRACT

An electromechanical device for removing material from an enclosed space, wherein the electromechanical device comprises at least one arm having at least one first attachment thereon, for fixing a cutter box and a suction device to cut and/or draw in the material that is to be removed from the enclosed space, a body attached to the arm for displacing the arm within the enclosed space, and at least one power source coupled to the body and configured to permit controlled movement of the device in the enclosed space. The electromechanical device also comprises, a first controller configured to receive movement controlling signals from a second controller located remote from the enclosed space and an attachment means that connects the device to equipment for lowering and raising the device in the enclosed space.

### FIELD

The present disclosure relates to electromechanical devices.

### BACKGROUND

Hydro-treating reactors of oil refineries are used to remove Sulphur, as well as other compounds, which are undesirable and detrimental to the stability and to the specifications of the product with respect to its performance and environment. Such compounds for example are unsaturated hydrocarbons and nitrogen from refinery process streams.

Hydro-treating reactors use a special kind of catalyst that becomes pyrophoric after normal cycle of use. Pyrophoric term is used for materials which are liable to ignite/heat-up spontaneously on exposure to air. The self-heating catalyst is spent after a few rounds of treatment of fuel, thereby increasing the need for replacing the self-heating catalyst. However, replacing the self-heating catalyst from hydro-treating reactors of oil refineries is a high risk job, as the catalyst requires inert gas blanketing to avoid exposure to oxygen gas. To perform this activity, a person needs to go inside the reactor with a breathing apparatus, as there is no oxygen inside. The activity to replace the self-heating catalyst takes several days to complete as there is a large amount of catalyst inside the reactor. Thus, any flaw in the breathing apparatus or an unfortunate incident can result in loss of life. Many refineries have faced fatal accidents while replacing the self-heating catalyst from the hydro-treating reactors. Also, the time taken by a person to replace the self-heating catalyst is very high which makes it an inefficient and an expensive exercise.

Thus, there is a need for developing a remotely controlled or an automated electromechanical device that can reduce the extent of manual work required in the activity of replacing the self-heating catalyst from the reactors, in order to make the activity hazard free and more efficient.

### SUMMARY

The present disclosure provides an electromechanical device for removing material from an enclosed space, wherein the device comprises, at least one arm having at least one first attachment thereon, for fixing a cutter box and a suction device to cut and/or draw in the material from the enclosed space, a body attached to the arm for displacing the arm vertically within the enclosed space, and at least one power source coupled to the body and configured to permit controlled movement of the device in the enclosed space. The electromechanical device also comprises a first controller configured to receive movement controlling signals from a second controller located remote from said enclosed space. An attachment means is provided on the device that connects the device to equipment for lowering and raising the device in the enclosed space. The first attachment of the electromechanical device comprises a clamp for removably attaching a cutter box and/or a suction hose with a suction inlet to the arms. The movement of the clamp inside the electromechanical device is controlled by the first controller and/or the second controller via one of the at least one power source.

The body of the electromechanical device comprises, a first and a second plate coupled with each other via a first bar such that the second plate is movable along the length of the first bar with respect to the first plate that is fixed, an arm attachment which is coupled with one of the at least one power source via a second bar resulting in the rotation and/or displacement of the arm attachment, and at least one actuator for each of the arms. The actuator/actuators is pivoted at the arm attachment and is also connected to each of the arms, which are also pivoted at the arm attachment, to provide displacement to the arms. The at least one power source is configured to receive signals and to provide movement to the second plate, rotation and/or displacement to the arm attachment and displacement to the arms, and power to cut the material by the cutter in accordance with the received signals.

In an embodiment, the electromechanical device is integrated with a stabilization system that includes a plurality of stabilization arms and at least one electric actuator for each of the stabilization arms. Each of the plurality of stabilization arms comprises a pneumatic actuator, a clamp, and a connecting member such that the clamp is configured to attach the pneumatic actuator to the connecting member which is coupled to the electromechanical device. The pneumatic actuator can have a telescopic configuration and may extend or retract to take support from the shell of the enclosed space to stabilize the electromechanical device therewithin.

In another embodiment, the cutter box comprises a plurality of interpenetrating cutter assembly that is configured to crush and shear the lumps of the material by exerting a force to produce a strain in the structure of the material. The plurality of interpenetrating cutter assembly may include a plurality of cutters, a shaft passing through each of the plurality of cutters, and a drive motor coupled to the shaft and configured to drive the shaft to facilitate the cutting and shearing of the material via the plurality of cutters.

In yet another embodiment, the arms have a foldable configuration and include a plurality of link members to facilitate increasing of the span of the electromechanical device by displacing or rotating the plurality of link members with respect to each other.

### OBJECTS

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide an electromechanical device that reduces human effort.

Another object of the present disclosure is to provide an electromechanical device that performs in an optimal manner from time and cost perspective.

Still another object of the present disclosure is to provide an electromechanical device that prevents loss of human life.

Yet another object of the present disclosure is to provide an electromechanical device that has a simple structure and is easy to operate.

Still another object of the present disclosure is to provide an electromechanical device that is remotely controlled.

Other objects and advantages of the present disclosure will be more apparent from the following description when read in conjunction with the accompanying drawing, which are not intended to limit the scope of the present disclosure.

### BRIEF DESCRIPTION OF THE ACCOMPANYING DRAWING

An electromechanical device of the present disclosure will now be described with the help of the accompanying drawing, in which:

FIG. 1 illustrates a side view of an electromechanical device, in accordance with an embodiment of the present disclosure;

FIG. 2A illustrates an isometric view of a vertical rack assembly of the electromechanical device of FIG. 1;

FIG. 2B illustrates another isometric view of the vertical rack assembly of the electromechanical device of FIG. 1;

FIG. 3A illustrates an isometric view of a rotating arm assembly of the electromechanical device of FIG. 1;

FIG. 3B illustrates another isometric view of the rotating arm assembly of the electromechanical device of FIG. 1;

FIG. 4A illustrates a front view of an extended portion of the rotating arm assembly of the electromechanical device of FIG. 1;

FIG. 4B illustrates a top view of the extended portion of the rotating arm assembly of the electromechanical device of FIG. 1;

FIG. 5 illustrates a block diagram of a control system that guides the electromechanical device of FIG. 1;

FIG. 6a illustrates a schematic view of a stabilization system integrated with the electromechanical device of FIG. 1;

FIG. 6b illustrates a detailed isometric view of the stabilization system of FIG. 6a;

FIG. 7a illustrates a side view of a first and a second arm of the electromechanical device of FIG. 1, in accordance with another embodiment of the present disclosure;

FIG. 7b illustrates another side view of the first arm of FIG. 7a;

FIG. 8a illustrates a bottom view of a cutter box of the electromechanical device of FIG. 1;

FIG. 8b illustrates an isometric view of the cutter box of FIG. 8a; and

FIG. 8c illustrates an isometric view of a cutter present inside the cutter box of FIG. 8a, in accordance with an exemplary embodiment of the present disclosure.

### DETAILED DESCRIPTION

An electromechanical device in accordance with an embodiment of the present disclosure will now be described with reference to the embodiments, which do not limit the scope and ambit of the disclosure. The description provided is purely by way of example and illustration. The embodiment herein, the various features, and advantageous details thereof are explained with reference to the non-limiting embodiments in the following description.

Descriptions of well-known components and processing techniques are omitted so as to not unnecessarily obscure the embodiments herein. The examples used herein are intended merely to facilitate an understanding of ways in which the embodiments herein may be practiced, and to further enable those of skill in the art to practice the embodiments herein. Accordingly, the examples should not be construed as limiting the scope of the embodiments herein.

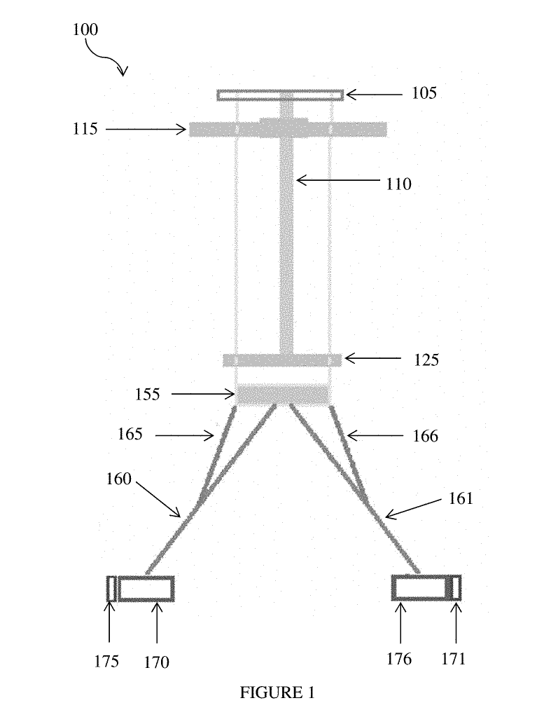

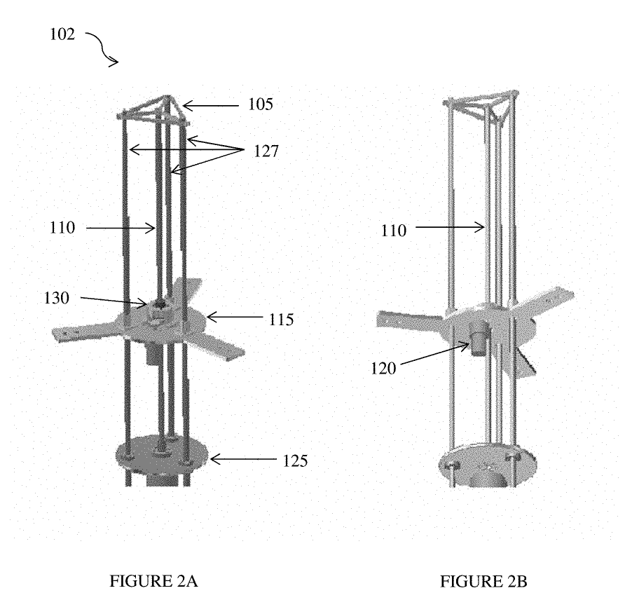

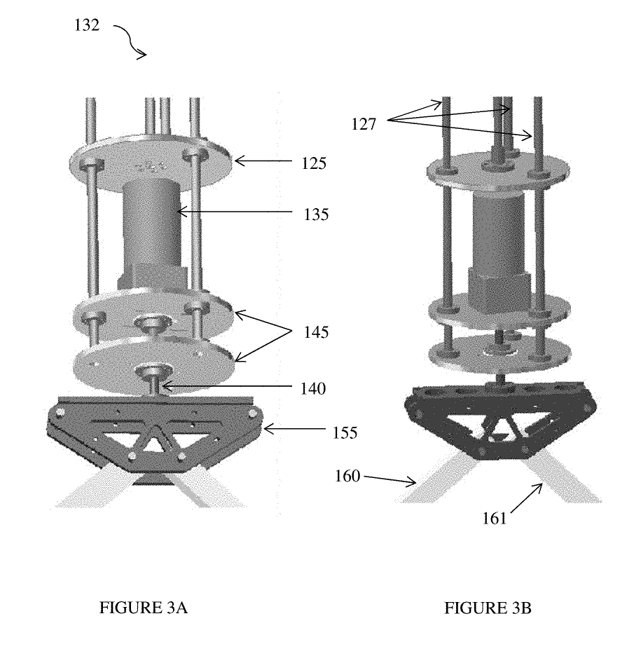

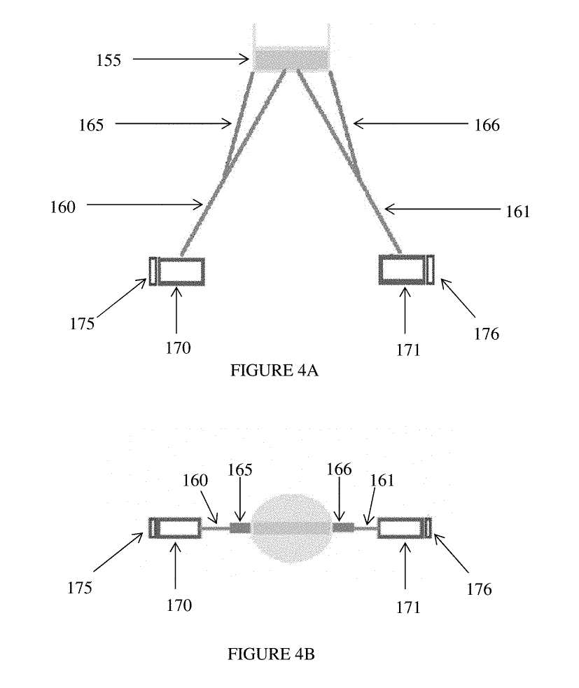

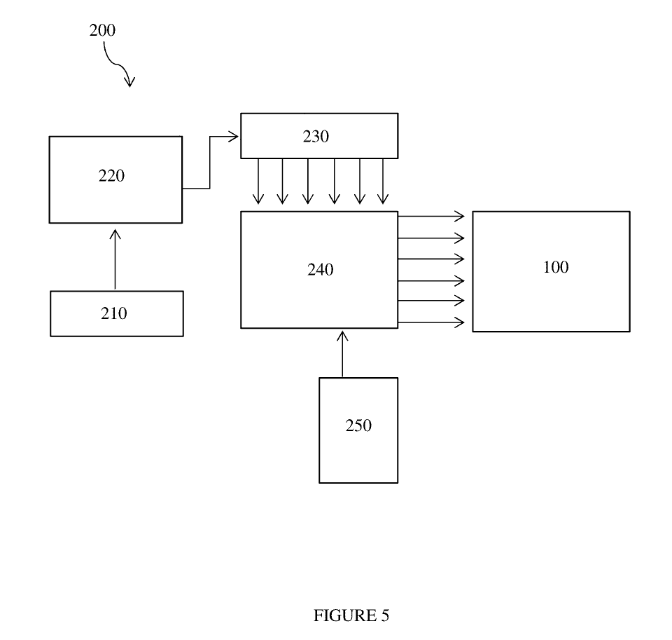

FIG. 1, FIG. 2A, FIG. 2B, FIG. 3A, FIG. 3B, FIG. 4A and FIG. 4B together depict an electromechanical device 100 comprising, a vertical rack assembly 102 that includes a guiding structure 105, a first bar 110, a first plate 115, a first power source 120, a second plate 125, at least one guide bar 127 and a ball-nut 130, a rotating arm assembly 132 that includes a second power source 135, a second bar 140, at least one non-rotating plate 145, an arm attachment 155, a first arm 160, a second arm 161, a first actuator 165, a second actuator 166, and at least one first attachment (not exclusively shown in the figures) that removably attaches a first cutter box 170, a second cutter box 171, a first suction device 175 and a second suction device 176 on the respective arms 160,161. A first controller (not shown in the figure) is also disposed on the electromechanical device 100. The FIG. 5 illustrates the electromechanical device 100 of the present disclosure being remotely controlled by a control system 200 that includes a second controller 210, a laptop 220, a microcontroller 230, at least one motor driver 240 and an electromechanical component 250. The first controller is configured to receive movement controlling signals from the second controller 210.

FIG. 2A and FIG. 2B illustrates an isometric view of the vertical rack assembly 102 of the electromechanical device 100, comprising the guiding structure 105, the first bar 110, the first plate 115, the first power source 120, the second plate 125, at least one guide bar 127 and the ball-nut 130. The guiding structure 105 is typically a rigid structure made of a strong material and is disposed at an operative top end of the electromechanical device 100. The first bar 110 is connected to the guiding structure 105 and extends in an operative downward direction from the guiding structure 105. Similarly, the at least one guide bar 127 is also connected to the guiding structure 105 and extends in an operative downward direction from the guiding structure 105. In one embodiment of the present disclosure, the first bar 110 and at least one guide bar 127 may be a rod, a wire, a rope, a shaft or a stick.

In the FIG. 2A and FIG. 2B of the present disclosure, there are three guide bars 127 that are individually located at an approximate distance of 100 mm from the first bar 110 and make an angle of 120 degrees between each other with respect to the first bar 110, which is extending from the guiding structure 105, typically from the center of the guiding structure 105. The number of guide bars 127 disclosed in the present disclosure does not limit the scope of the disclosure to the use of three guide bars 127 and can have more or less number of guide bars 127 to provide support and strength to the electromechanical device 100. In one embodiment of the present disclosure, the at least one guide rod 127 and the first bar 110 are integrally connected to the guiding structure 105. The first plate 115 is located operatively below the guiding structure 105 and comprises a hole for each of the first bar 110 and the three guide rods 127 such that the first bar 110 and the three guide rods 127 pass through the first plate 115.

An attachment means 178 is removably attached to the first plate 115 and is connected to equipment (not shown in the figures) for lowering and raising the electromechanical device 100 in the enclosed space. The attachment means 178 can be a rod, a wire, a rope, a shaft or a stick. After the electromechanical device 100 is lowered in the confined space of the reactor with the help of the attachment means 178, the electromechanical device 100 tends to swing within the reactor which is not desired.

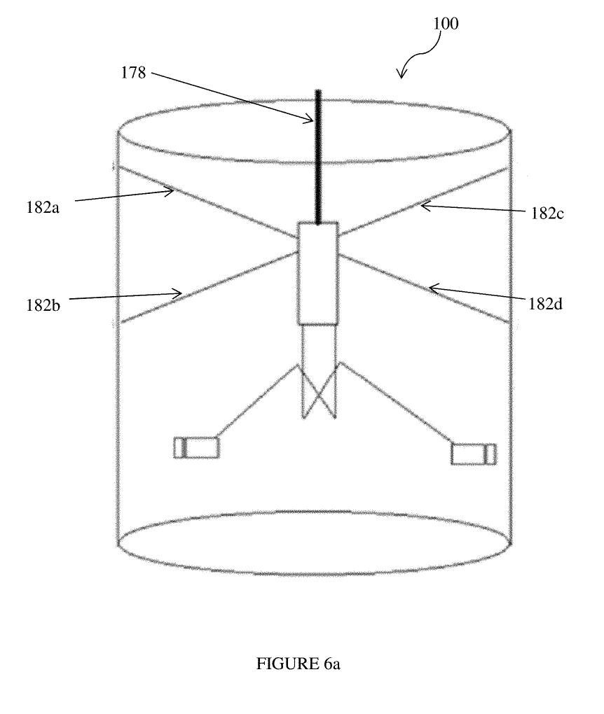

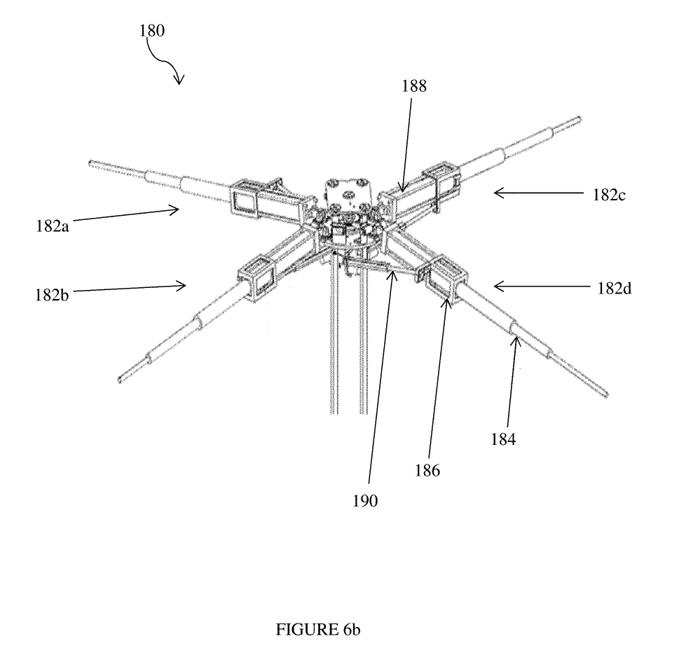

To stabilize the undesired movement of the electromechanical device 100 inside the reactor, a stabilization system 180 is integrated with the electromechanical device 100. FIG. 6a and FIG. 6b illustrates a schematic and an isometric view of the stabilization system 180 respectively. The stabilization system 180 includes a plurality of stabilization arms 182a, 182b, 182c, and 182d. Each of the stabilization arms 182a, 182b, 182c, and 182d comprises a pneumatic actuator 184, a clamp 186, and a connecting member 188. The clamp 186 is configured to attach the pneumatic actuator 184 to the connecting member 188 that is coupled to the electromechanical device 100. In an embodiment, the pneumatic actuator 184 has a telescopic configuration. The pneumatic actuator 184 is configured to extend and retract to take support from the shell of the reactor (enclosed space) to stabilize the electromechanical device 100.

In another embodiment, the stabilization system 180 further comprises at least one electric actuator 190 for each of the stabilization arms 182a, 182b, 182c, and 182d. In an embodiment, each of the electric actuator 190 is configured to rotate the respective stabilization arms 182a, 182b, 182c, and 182d by ninety degrees with respect to the folded position of the stabilization arms 182a, 182b, 182c, and 182d.

The vertical rack assembly 102 also comprises six linear bearings (not disclosed in any of the figures) for the three guide rods 127 such that a set of three linear bearings are mounted on the upper flat surface of the first plate 115 on top of the holes configured thereon, and the remaining set of three bearings are mounted on the lower flat surface of the first plate 115 on the holes configured thereon. Further, the ball-nut 130 of the vertical rack assembly 102 is mounted on the top surface of the first plate 115 on top of the hole through which the first bar 110 passes. In one embodiment, the first bar 110 passes through the center of the first plate 115. The three guide bars 127 and the first bar 110 are configured to pass through the bearings and the ball-nut 130 respectively. The guiding structure 105 is configured to keep the guide bars 127 equidistant from the center.

The vertical rack assembly 102 comprises the second plate 125 which is located below the first plate 115. The first bar 110 that pass through the respective hole provided on the first plate 115 is extended towards the second plate 125 and is connected to the second plate 125. Similarly, the three guide rods 127 that pass through the respective holes provided on the first plate 115 are extended towards the second plate 125. However, the three guide rods 127 also pass through the holes provided on the second plate 125. In one embodiment of the present disclosure the holes for the three guide rods 127 on the second plate 125 are coaxial to the holes for the three guide rods 127 on the first plate 115. The second plate 125 is movable with respect to the first plate 115 along the length of the first bar 110. In one embodiment of the present disclosure, the first bar 110 acts like a screw rod having threads thereon. In the same embodiment, the first power source 120 receives a signal from the control system 200 and thereby provides a rotary motion to the ball-nut 130, wherein the rotary motion of the ball-nut 130 is converted into a reciprocating motion of the screw rod/first bar 110 by the threads configured thereon. In one embodiment of the present disclosure, the first power source 120 may be a wind-up motor, an electric motor, a rotary actuator, a gear mechanism, a hydraulic mechanism and a pneumatic mechanism. In another embodiment of the present disclosure, the conversion of rotary motion into a reciprocating motion as disclosed herein may also be done with a motorized chain pulley and guide rod mechanism, rack and pinion mechanism, hydraulic mechanism and the like. The ball-nut 130 and the threads on the screw rod do not restrict the movement of the first bar 110 completely, but limit it along the length of the first bar 110, thereby displacing the second plate 125 along the length of the first bar 110.

FIG. 3A, FIG. 3B, FIG. 4A and FIG. 4B illustrate the rotating arm assembly 132 of the electromechanical device 100, comprising the second power source 135, the second bar 140, at least one non-rotating plate 145, the arm attachment 155, the first arm 160, the second arm 161, the first actuator 165, the second actuator 166, and the at least one first attachment that removably attaches the first cutter box 170, the second cutter box 171, the first suction device 175 and the second suction device 176 to the first and the second arm 160,161 respectively.

The at least one non-rotating plate 145 is located below the second plate 125 and is rigidly coupled to the second plate 125 via the extended guide rods 127. In one embodiment of the present disclosure, the second power source 135 is integrally connected to the second plate 125 and/or to the at least one non-rotating plate 145. In another embodiment of the present disclosure, the second power source 135 may be a wind-up motor, an electric motor, a rotary actuator, a gear mechanism, a hydraulic mechanism and a pneumatic mechanism. The second power source 135 is controlled by the first controller, which receives movement controlling signals from the second controller 210. The three guide bars 127 that pass through the first plate 115 and the second plate 125 are extended towards the at least one non-rotating plate 145 and are removably attached to the at least one non-rotating plate 145. In one embodiment of the present disclosure, the three guide bars 127 are integrally connected to the second plate 125. The at least one non-rotating plate 145 and the three guide bars 127 are provided in the electromechanical device 100 merely to support the assembly of the essential elements and do not limit the scope of the present disclosure.

The second power source 135 of the rotational arm assembly 132 is coupled with the arm attachment 155 via the second bar 140. The second power source 135 receives signal from the first controller (not shown in the figure) and provides a rotary motion to the second bar 140, wherein the rotary motion of the second bar 140 is transferred to the arm attachment 155, thereby rotating the arm attachment 155. In the arm attachment 155, both the first and the second arm 160,161 and both the first and the second actuator 165,166 are pivoted, thus resulting in the rotation of the first and the second arm 160,161 along with the first and the second actuator 165,166. The first and the second actuators 165,166 are also removably attached to the first and the second arm 160,161 respectively and are configured to rotate or displace the first and the second arm 160,161. The first and the second actuator 165, 166 are driven by a third power source (not shown in the figures) under the guidance of the first controller. In one embodiment of the present disclosure, the first and the second arm 160,161 forms a shape of inverted letter ‘V’, with motorized first and second actuator 165,166 attached in a manner such that the angle between the arms 160,161 can be changed from 0 degree to 180 degrees, wherein 0 degree configuration means both the arms 160,161 are pointing downward and 180 degrees configuration means one arm at angle of (+) 90 degrees and other arm at (−) 90 degrees with respect to their zero degree configuration respectively.

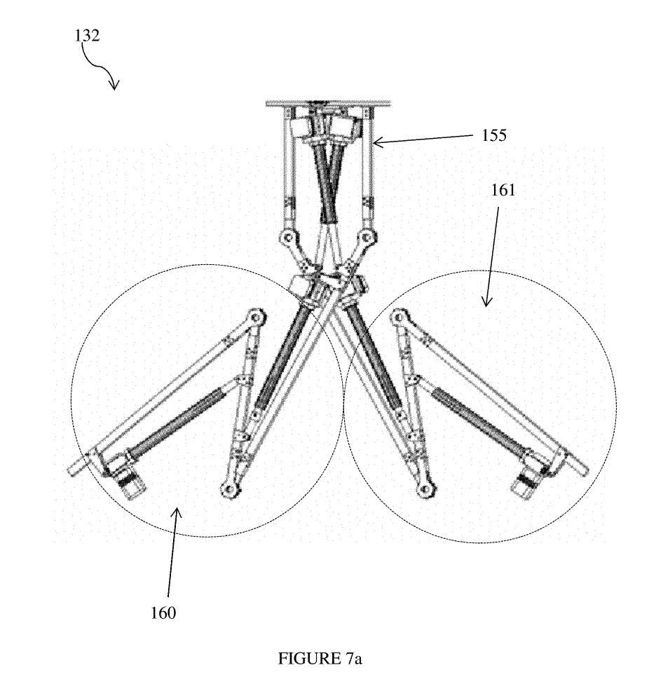

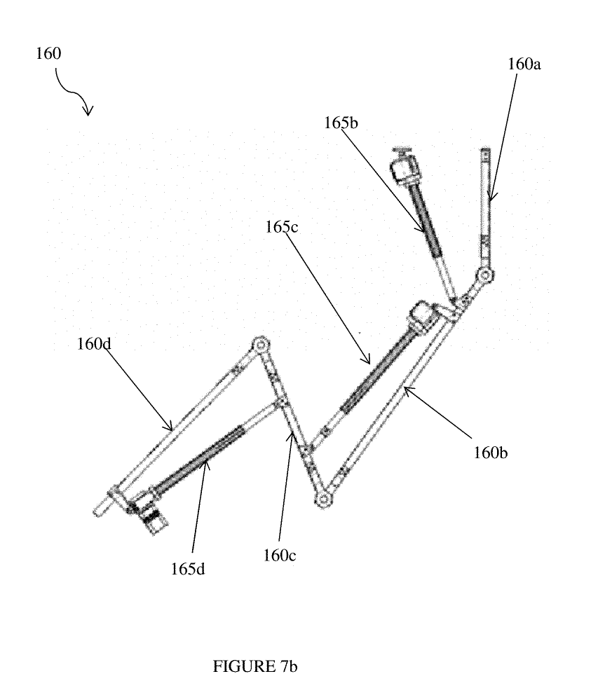

In an embodiment of the present disclosure, each of the first and the second arm 160,161 has a foldable configuration. FIG. 7a and FIG. 7b illustrate the side views of the first and the second arm 160,161 having the foldable configuration. Each of the foldable arms 160,161 is defined by a plurality of link members. The present embodiment is described with reference to the foldable configuration of the arm 160 having the plurality of link members 160a, 160b, 160c and 160d. The link member 160a is fixedly attached to the arm attachment 155. Each of the remaining link members 160b, 160c and 160d are configured to rotate by means of electric actuators 165b, 165c and 165d respectively. The number of link members and respective electric actuators do not limit the scope and ambit of the present embodiment and can be two or more.

The foldable configuration of the first and the second arms 160, 161 are similar, and therefore, for the sake of the brevity of the present disclosure, the description of the second foldable arm 161 has not been repeated. The foldable configuration of the first and the second arm 160, 161 facilitates increasing the span of the electromechanical device 100 by rotating the plurality of link members 160b, 160c and 160d with respect to each other. The foldable configuration of the first and the second arm 160, 161 is configured to maintain compactness of the electromechanical device 100 while entering the reactor through a narrow opening.

The first and the second arm 160,161 have at least one first attachment that removably attaches the first and second cutter boxes 170,171 and the first and second suction device 175,176 on the first and second arm 160,161 respectively. In one embodiment of the present disclosure an actuator, a cutter box and a suction device is provided for each arm installed in the electromechanical device 100 and at least one arm is required to operate the electromechanical device 100, therefore, the number of arms, actuators, cutter boxes, suction devices do not limit the scope of the present disclosure. The first and second suction devices 175,176 constitute a suction hose with a suction inlet (not shown in the figures), which in turn is connected to a suction system (not shown in the figures) which is placed outside the reactor. Once the suction system is switched on, the first and the second suction devices 175,176 draws in a material lying in the vicinity of the suction devices 175,176 via the suction inlet and transfer the drawn in material to a storage device (not shown in the figure) via the suction hose. The first and the second suction devices 175,176 can be moved again and again on top of the surface of the material in a continuous manner until the material is drawn in completely. If the material is in the form of a lump, the cutter of the first and the second cutter boxes 170,171 is used to first break that lump into smaller pieces and then these smaller pieces are drawn in through the first and the second suction devices 175,176. The signal to the first and the second cutter boxes 170,171 to cut/break the lump into smaller pieces is given by the first controller under the guidance of the second controller 210 which is a part of the control system 200 via a fourth power source (not disclosed in the figure).

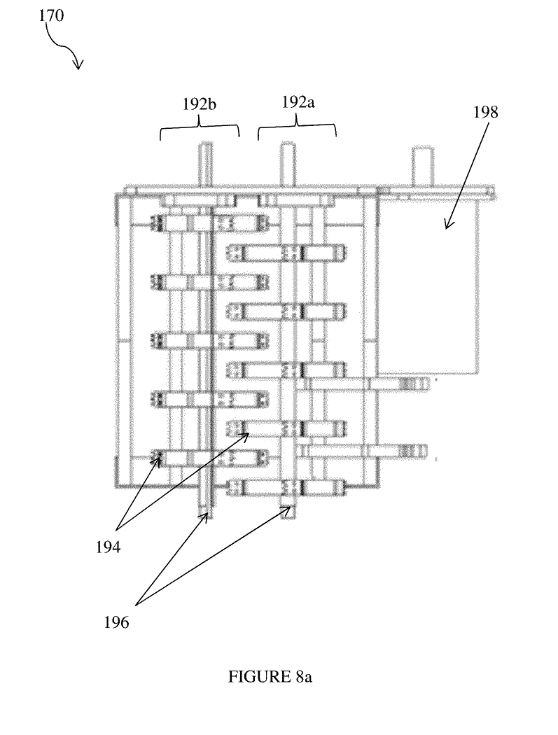

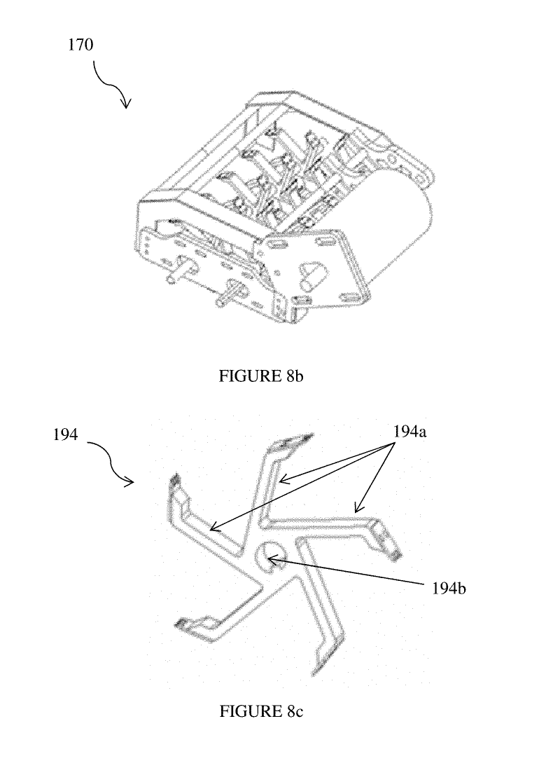

Each of the first and the second cutter boxes comprise a plurality of interpenetrating cutter assembly that is configured to crush and shear the lumps of the material by exerting a force that produces a strain in the structure of the material. FIGS. 8a and 8b illustrate a bottom view and an isometric view of the cutter box 170 of the first arm 160 respectively. The cutter box 170 comprises a plurality of cutter assemblies 192a and 192b, each of which includes a plurality of cutters 194, and a shaft 196 passing therethrough. The cutter box 170 further comprises a drive motor 198 coupled to each of the shaft 196 of the plurality of cutter assemblies 192a, 192b. The drive motor 198 is configured to drive the shaft 196 to facilitate the cutting and shearing of the material via the plurality of cutters 194.

In an embodiment, the drive motor 198 is coupled to the shaft 196 of the plurality of cutter assemblies 192a, 192b using standard drive mechanism selected from the group consisting of timing pulley, plate, V-belt, and chain sprocket. In another embodiment, the cutter box 170 is mounted on the first arm 160 by means of at least one lug disposed in the cutter box 170. The configuration of the cutter box 170 of the first arm 160 is similar to the cutter box 171 of the second arm 161, and therefore, for the sake of the brevity of the present disclosure, the description of the cutter box 171 of the second arm 161 has not been repeated.

FIG. 8c illustrates an oblique view of a cutter of the plurality of cutters 194 of each of the cutter boxes, in accordance with an exemplary embodiment of the present disclosure. Each of the cutters of the plurality of cutters 194 is defined by a plurality of blades 194a and a central hole 194b that is configured to facilitate passing of the shaft 196 there through.

With the simultaneous use of the vertical rack assembly 102 and the rotational arm assembly 132, and the at least one first attachment, the cutter boxes 170/171 and the suction devices 175,176 can reach every point of the enclosed space (not disclosed in any of the fig.). The electromechanical device can be used for various other applications where there is a need of removal of a material from an enclosed space or cavity. The arms 160,161 of the present disclosure are made of an aluminium alloy like duralumin that provides strength to the arms and also keeps the weight of the arms low. Other parts of the electromechanical device 100 are typically made of steel. The arms and other parts of the electromechanical device 100 can be made of any material that provides high strength and durability, and keeps the weight of the electromechanical device 100 low and therefore, the materials used to manufacture the parts of the electromechanical device 100 do not limit the scope of the present disclosure.

The FIG. 5 illustrates a block diagram of the control system 200 of the electromechanical device 100, comprising the second controller 210, the laptop 220, the microcontroller 230, at least one motor driver 240, and the electromechanical component 250. The number of motor drivers 240 required in the control system 200 is equal to the combined number of motors, actuators, pneumatic systems, and hydraulic systems that are provided on the electromechanical device 100 and are controlled via the first controller. In an embodiment, the first controller is located remotely and can be the laptop 220. However, the number of motor drivers 240 does not limit the scope of the present disclosure. The second controller 210 is manually controlled and is configured to pass a signal via the second controller 210 to the laptop 220. The laptop 220 then converts the signal using pre-determined software and passes the converted signal to the microcontroller 230 using a serial communication. The microcontroller 230 then splits the converted signal for each of the motor driver 240 and passes the split signals to each of the respective motor driver 240. The electromechanical component 250 acts as a power source and drives the motor drivers 240. In one embodiment of the present disclosure, 24V power is provided to all the motor drivers 240. The first power source 120, the second power source 135, the third power source and the fourth power source receive their movement controlling signals from the respective motor drivers 240.

The control system 200 automates the electromechanical device 100 and thus reduces human effort to a large extent. The control system 200, the vertical rack assembly 102, the rotational arm assembly 132 and the at least one first attachment help the electromechanical device 100 to perform in an optimal manner from time and cost prospective. The automated electromechanical device 100 has a simple structure and is easy to operate. The automated electromechanical device 100 also prevents loss of human life by reducing the amount of time a human being has to stay inside an oxygen less enclosed space.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

### TECHNICAL ADVANCES AND ECONOMICAL SIGNIFICANCE

The electromechanical device, in accordance with the present disclosure described herein above has several technical and/or economic advantages including but not limited to the realization of an electromechanical device that:
reduces human effort;
performs in an optimal manner from time and cost prospective;
prevents loss of human life;
has a simple structure and is easy to operate; and
is remotely controlled.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or mixtures or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form part of the prior art base or were common general knowledge in the field relevant to the disclosure, as it existed anywhere before the priority date of this application. The numerical value mentioned for the various physical parameters, dimensions or quantities are only approximations and it is envisaged that the values higher/lower than the numerical values assigned to the parameters, dimensions or quantities fall within the scope of the invention, unless there is a statement in the specification specific to the contrary.

While considerable emphasis has been placed herein on the specific features of the preferred embodiment, it will be appreciated that many additional features can be added and that many changes can be made in the preferred embodiment without departing from the principles of the invention. These and other changes in the preferred embodiment of the invention will be apparent to those skilled in the art from the disclosure herein, whereby it is to be distinctly understood that the foregoing descriptive matter is to be interpreted merely as illustrative of the invention and not as a limitation.

1. An electromechanical device for removing material from an enclosed space, said device comprising,
at least one arm having at least one first attachment thereon, for fixing a cutter box and a suction device to cut and/or draw in material from said enclosed space;
a body attached to said arm for displacing said arm within said enclosed space; and
at least one power source coupled to said body and configured to permit controlled movement of said device in said enclosed space.

2. The electromechanical device as claimed in claim 1, which includes
(i). a first controller configured to receive movement controlling signals from a second controller located remote from said enclosed space; and
(ii). an attachment means for connecting the device to equipment for lowering and raising said device in said enclosed space.

3. The electromechanical device as claimed in claim 1, wherein said device is integrated with a stabilization system that includes a plurality of stabilization arms and at least one electric actuator for each of the stabilization arms.

4. The electromechanical device as claimed in claim 3, wherein each of said plurality of stabilization arms comprises a pneumatic actuator, a clamp, and a connecting member such that said clamp is configured to attach said pneumatic actuator to said connecting member coupled to said electromechanical device.

5. The electromechanical device as claimed in claim 4, wherein said pneumatic actuator has a telescopic configuration and is configured to extend and retract to take support from the shell of said enclosed space to stabilize said electromechanical device there within.

6. The electromechanical device as claimed in claim 2, wherein said first attachment comprises a clamp for removably attaching a cutter box and/or a suction hose with suction inlet to said arm, wherein the movement of said clamp is controlled by said first and/or second controller via one of said at least one power source.

7. The electromechanical device as claimed in claim 6, wherein said cutter box comprises a plurality of interpenetrating cutter assembly that is configured to crush and shear the lumps of the material by exerting a force to produce a strain in the structure of the material.

8. The electromechanical device as claimed in claim 7, wherein each of said plurality of interpenetrating cutter assembly includes a plurality of cutters, a shaft passing through each of said plurality of cutters, and a drive motor coupled to said shaft and configured to drive said shaft to facilitate the cutting and shearing of the material via said plurality of cutters.

9. The electromechanical device as claimed in claim 1, wherein said body comprises, a first and a second plate coupled with each other via a first bar such that said second plate is movable along the length of said first bar with respect to said first plate that is fixed, an arm attachment which is coupled with one of said at least one power source, mounted on said second plate, via a second bar resulting in the rotation of said arm attachment, and at least one actuator for each of said arms.

10. The electromechanical device as claimed in claim 9, wherein:
(i). said at least one actuator is pivoted at said arm attachment and connected to each of said arm, which are also pivoted at said arm attachment, to provide rotation to said arm;
(ii). said at least one power source is configured to receive signals and to provide said movement to said second plate, said rotation to said arm attachment, said displacement to said arms, and cutting of said material by a cutter of said cutter box in accordance with the received signals; and
(iii). said body includes a guiding structure located at an operative top end thereof connected to said first bar and at least one fixed plate coupled with said second plate, configured to provide strength and durability to said body.

11. The electromechanical device as claimed in claim 9, which includes a ball nut fitted on said first plate such that said first bar having threads thereon passes through said ball nut and rotation of said ball nut over said first bar induces the relative motion between said second plate and said first plate.

12. The electromechanical device as claimed in claim 10, which includes at least one guide bar extending from said guiding structure in an operatively downward direction and passes through said first plate and said second plate and connects to said at least one fixed plate merely to provide support to said plates.

13. The electromechanical device as claimed in claim 1, wherein said at least one power source is selected from the group of wind-up motors, electric motors, rotary actuators, spur gears, hydraulic system and pneumatic system.

14. The electromechanical device as claimed in claim 2, wherein said first bar and/or said second bar and/or the attachment means is selected from the group of a rod, a wire, a rope, a shaft and a stick.

15. The electromechanical device as claimed in claim 1, wherein said arm has a foldable configuration and includes a plurality of link members to facilitate increasing of the span of said electromechanical device by rotating said plurality of link members with respect to each other.
